(19) United States
(12) Patent Application Publication
(10) Pub. No.: US 2026/0359919 A1
(43) Pub. Date: Nov. 12, 2026

(54) METHOD FOR IDENTIFYING A VEHICLE, AND SYSTEM FOR CARRYING OUT THE METHOD

(71) Applicant: TÖNNJES ISI PATENT HOLDING GMBH, Delmenhorst (DE)

(72) Inventors: Albertus Jacobus PRETORIUS, Karalee (AU); Jörn BERTRAM, Bremen (DE)

(73) Assignee: TÖNNJES ISI PATENT HOLDING GMBH, Delmenhorst (DE)

(21) Appl. No.: 19/130,729

(22) PCT Filed: Oct. 4, 2023
(86) PCT No.: PCT/EP2023/077416

§ 371 Date: May 16, 2025

(30) Foreign Application Priority Data
Nov. 17, 2022 (DE) 10 2022 130 403.5

(51) Int. Cl. G06Q 50/26; G06K 7/10; G08G 1/017

(52) U.S. Cl. CPC G06Q 50/265; G06K 7/10297; G08G 1/017

(57) ABSTRACT

A method for identifying a vehicle, and a system for carrying out the method, wherein the identity of the vehicle can be verified in a fast and reliable manner. This is achieved by RFID transponders, but at least one RFID transponder, on which the vehicle data to be identified and/or the vehicle owner are stored, and/or an RFID transponder that identifies a component of the vehicle and at least one further RFID transponder is attached to the same vehicle are read by at least one RFID reader. The data from all RFID transponders of the same vehicle are stored, specifically together with the location and time at which the data was read, in a central or local data memory. The data set that has been read is then analyzed by an analysis device. The data set that has been read is evaluated with a quality factor by the analysis device.

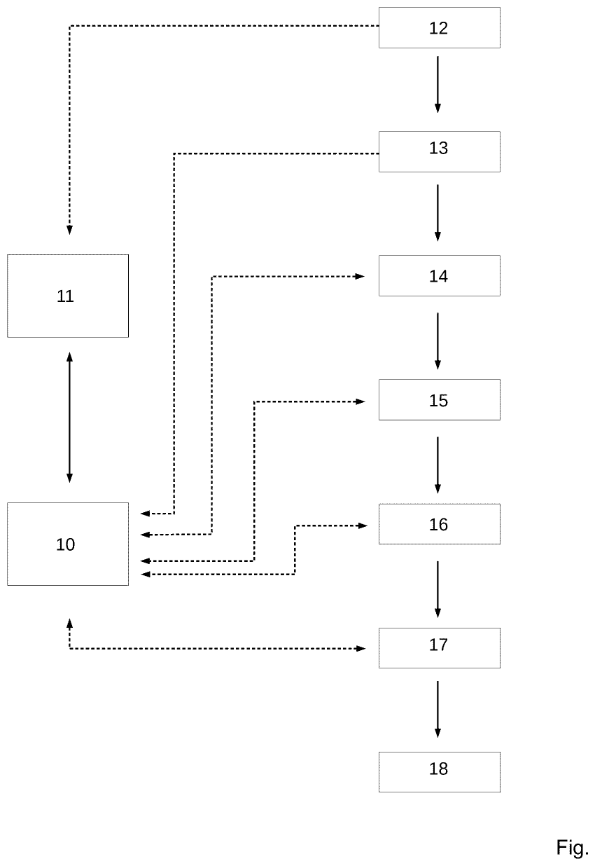

The invention relates to a method for identifying a vehicle as claimed in claim 1. The invention furthermore relates to a system for carrying out the method for identifying a vehicle as claimed in claim 20.

The forging of vehicle identities is increasingly becoming a serious problem. Vehicles, and in particular motor vehicles and commercial vehicles, are primarily identified by their license plate, which is issued and checked by the relevant authorities. These officially regulated vehicle license plates or number plates are also used for vehicle-related services, for example to record parking fees, toll fees and the like. In known methods for detecting license plates, optical or imaging devices, such as cameras, are used. However, these imaging methods do not allow the authenticity of the vehicle license plate or the vehicle to be detected.

In addition to the visible number plates, the vehicle identification number (VIN) is another vehicle identifier that is usually affixed by the vehicle manufacturer in the form of a barcode label on the vehicle frame. Similarly, the engine is clearly identified by an engine number. However, to verify the authenticity of these numbers, the vehicle must be stopped and checked. Another disadvantage of these numbers is that they are known to be easy to forge. Such forgeries are used in motor vehicle crime, for example to legitimize stolen vehicles.

The increasing number of vehicles on the roads limits the authorities' ability to detect forged number plates, especially when the forged license plates are used to mark similar vehicles from different regions or even different countries. Neither humans nor technologies that are currently in use are able to identify the authenticity of the vehicle by means of photographs that have been taken.

Locating methods with a time stamp can be used to determine the location of a vehicle or a license plate at a specific time. If this vehicle or license plate is sighted at two different locations at a similar time, it can be assumed that only one of the vehicles has been legally authorized by the relevant authority. However, which of the two vehicles is authorized and which is not cannot be determined by this method. Stopping and checking a vehicle can only be carried out at random. Apart from the fact that such a check requires a lot of personnel, only a small fraction of vehicles can be checked on the roads.

Another problem in identifying and checking the authenticity of vehicle license plates is that it is problematic to intervene retrospectively in an automatically detected vehicle with a suspicious identity. If, for example, a vehicle that is traveling too fast is recorded by a radar camera and a forged license plate is identified by the relevant police department, the vehicle has already absconded and can no longer be identified at this time.

It is known to use transponders that can be read contactlessly, in particular RFID or NFC transponders or tags, to mark vehicles. Similarly, passive UHF radio identification (RFID), also known as RAIN-RFID or simply RAIN, is increasingly becoming the standard for marking any parts during manufacture. Such marking makes it possible, for example, to track and monitor the life cycle of the part by means of regular readings. This includes manufacturing, testing, distribution, installation, in-use monitoring and end-of-life management. Meanwhile, vehicle manufacturers have also discovered RAIN RFID as a method for improving transparency in relation to new and retrofitted parts.

RAIN RFID transponders are also increasingly being used to identify vehicles for compliance with legal requirements and to impose road user charges, such as parking fees and toll fees. Vehicle identification is used for compliance with road regulations and for enforcement services, as well as for payment and other vehicle management and vehicle linking services such as fleet management. Fleet managers (rental cars, taxis, construction companies, etc.) can link identifications of specific parts or vehicle parts in their fleet management systems to a vehicle identifier which is usually applied by the fleet owner to manage the parts of a vehicle. These identification groups are usually read during maintenance and when passing through gates under the control and record-keeping remit of the fleet owner.

The number of identifiers or tags/transponders that can be detected by a reader on a vehicle is increasing steadily as more and more parts are being provided with these tags. In Europe, vehicles usually have more than 20 such part markings.

Devices for reading the identifier or the transponders or tags may be, for example, road readers, which are permanently installed above or next to or also integrated into roadways. Similarly, these devices may also be transportable or portable readers used in a road block for stop-and-go checks and for controlling the flow of traffic.

As already mentioned above, RAIN RFID is a radar technology in which the reader sends a modulated signal to the identifier or the transponder or tag. This signal is used to supply power to the transponder and to send commands to the transponder. The transponder reflects the signal from the reader. If the reader no longer modulates the signal, i.e. it only delivers an unmodulated signal, the so-called constant wave or CW signal, the transponder responds with a modulation of the signal reflection. This means that the communication between the reader and the transponder is within sight and is limited in range and scope. The reading area is typically the size of a typical sedan with a length of 6 m and a height and width of 4 m.

Known RAIN RFID transponders have three memory locations, namely 1.) Inventory data that are read out when the label is identified. Inventory data is typically an identification number of the marked item, such as the part number assigned by the part manufacturer. 2.) The transponder identification, which is a guaranteed unique number. These data must also be read after the transponder has been inventoried. Reading these data is not common practice. 3.) User data that relates to additional attributes of the marked object. Such user data is also unusual. Regulatory vehicle identification labels typically introduce authentication data into this memory location. These data must also be read after the transponder has been inventoried. This reading is not common in the case of non-regulatory vehicle identification labels.

Proceeding from the aforementioned problems, the object of the present invention is to provide a method for identifying a vehicle and a system for carrying out the method by means of which the identity of the vehicle can be verified in a fast and reliable manner.

A method for achieving this object comprises the measures from claim 1. Provision is made here for a plurality of RFID transponders, but at least one RFID transponder, on which data about the vehicle to be identified and/or the vehicle owner are stored, and/or an RFID transponder that identifies a component of the same vehicle and at least one further RFID transponder that is attached to the same vehicle to be read by at least one RFID reader. The data that has been read in this way from all RFID transponders of the same vehicle are stored, together with the location and time at which the data was read, in a central or local data memory. This set of data that has been read is referred to below as a data set. According to an additional step, the data set that has been read is analyzed by an analysis device. The data set that has been read is evaluated with a quality factor by the analysis device. This quality factor is assigned to this data set and stored in the data memory together with the data set. If additional RFID transponders of a vehicle are read at a later time and corresponding data sets are created, these data sets are compared with the previously recorded data sets and their quality factors. Based on this comparison of the data sets and/or the quality factors, the analysis device generates a plausibility factor indicating the plausibility or probability of two data sets that have been recorded at different times belonging to the same vehicle. A high plausibility value indicates a high probability that the vehicles that have been recorded at different times are the same vehicle and that a forgery of the identity can virtually be ruled out. The quality factor plays a decisive role in the evaluation or determination of plausibility. The more transponders of a vehicle are detected at a certain time and at a certain location and the data stored on the transponders are combined to form a data set, the greater the quality factor. If, on the other hand, only one transponder can be detected or read from a vehicle, the quality factor of this data set is very low. The quality factor can also be increased or improved by repeatedly detecting or recognizing and reading the transponders of the same vehicle at different times and locations. Similarly, the quality factor assigned to a particular vehicle may also decrease or worsen if individual transponders are missing when the transponders of this vehicle are read again. If missing or new transponders are detected by the reader, this is evaluated by the analysis device. If the analysis unit detects two data sets that have been read from the transponders of a vehicle at different times at different locations, and the data sets or essential information correspond at least to the greatest extent possible, the plausibility factor is determined taking into account the quality factors. The invention thus uses the increasing number of RAIN transponders on a vehicle to automatically profile the identity of the vehicle without violating the privacy of the persons using the vehicle, with the aim of detecting potential vehicle identity fraud, i.e. vehicles with a suspicious identity.

The invention preferably also makes provision, when the plurality of RFID transponders, in particular the above-mentioned transponders, of a vehicle are read at a later time, for the quality factor of a data set belonging to the same vehicle to be updated. It should be expressly noted that an update is not mandatory when the vehicle is re-detected. If, when the vehicle is re-detected, for example, additional or new characteristics of the vehicle or additional RFID transponders that were not previously stored in the stored data set are acquired, these new data can be added to the existing data set. This addition of additional information about the vehicle to the data set can improve the quality factor of the data set. If, on the other hand, information or RFID transponders are missing from the vehicle when the vehicle is re-detected, it is possible for the analysis device not to change the stored data set for this vehicle or for data to be deleted accordingly, which can lead to a reduction in the quality factor of this data set. By continuously updating the data set and thus the quality factor of a vehicle, the plausibility factor used to evaluate the identification of a vehicle can also be improved.

Preferably, the invention may also make provision for at least one camera to be used to determine additional visible data of the vehicle (visual information), namely the color, the brand, the type, the vehicle components, the color of the trim, the shape and color of the dashboard, the tires and/or the shape of the vehicle, and for these data to also be stored in the data set and analyzed. In addition, it is conceivable that at least one additional sensor, in particular a microphone or sensor for detecting vibrations, is used to determine the noise (acoustic information) of the tires, the shock absorbers, the exhaust and/or the drive chain or similar and these data are also stored in the data set and analyzed. The quality factor of the data set can be further improved through the acquisition of at least some visual and/or acoustic information. It proves to be particularly advantageous that some of this information, such as noise, is difficult to forge.

One particular exemplary embodiment of the invention makes provision for data sets that do not reach a value to be stipulated, in particular a threshold value, for a quality factor, because too few transponders have been detected or other data or information are/is missing, not to be used for further identification of the vehicle, in particular for generating a plausibility factor. If, for example, only one RFID transponder is read or only one piece of visual information is detected, the quality factor would therefore be very low and only a small degree of significance can be attributed to the comparison between two vehicles that have been detected at different times. The comparison of data sets from vehicles that have been acquired at different times therefore requires a minimum level of data or a minimum quality factor. This threshold value can be freely selected by the user in the analysis device. However, a high quality factor does not have to be equivalent to a large data set. If, for example, a vehicle with two, three or four or more transponders is detected regularly and in the process all transponders are always read and the same number of transponders are detected each time the transponders are re-detected, this data set may have a high quality value.

The invention also preferably makes provision for the calculated plausibility factor from which two data sets that have been recorded consecutively can be assigned to the same vehicle to be stipulated. Stipulating such a value can change the quality of the validity of whether the same vehicle is really involved. A high plausibility factor in this case means a high probability for the authentication or identification of the vehicle. A lower plausibility factor, on the other hand, indicates a lower probability that the detected similarity of the data sets actually belongs to the same vehicle.

In addition, an additional exemplary embodiment of the invention consists in a signal being generated when a stipulated plausibility factor that must be reached for two data sets that have been recorded consecutively to be attributed to the same vehicle is undershot. Such a signal may be, for example, a message to an official institution, such as the police. This will immediately alert the police if a potential forgery of a vehicle license plate is detected so that they can intervene immediately and verify the potential identity theft.

One particularly preferred exemplary embodiment of the invention furthermore makes provision for the analysis unit to search the data sets for known RFID transponders already detected at an earlier time and assigned to a vehicle and, in the absence of an already detected RFID transponder in the data set, the analysis unit to determine what part been indicated by said RFID transponder. If an RFID transponder on a vehicle is detected for the first time, i.e. the data of this transponder has not been stored in the data set, the analysis unit determines what has been indicated by this RFID transponder.

In the event that an RFID transponder is missing for a known vehicle or a known data set, the analysis unit decides whether this missing RFID transponder can be omitted for the assignment of the data set to a particular vehicle. In this case, for example, the missing RFID transponder can be added to the data set by pattern recognition, preferably artificial intelligence. The absence of the transponder can thus be compensated if necessary, as a result of which it is still possible to assign the acquired data set to a vehicle and to compare same with previously acquired data sets. If an RFID transponder is detected for the first time, the pattern recognition, which may also be artificial intelligence, can also determine whether this RFID transponder matches the already known data set and this transponder may be added to the data set. If, however, pattern recognition detects that this transponder does not match the existing data set, because it identifies, for example, a handbag lying in the vehicle, these data are not added to the data set. However, if the newly detected RFID transponder is an identifier for a new navigation system, this can be added to the already known data set.

If an already known data set is changed due to a newly detected RFID transponder or a non-detected RFID transponder, the quality factor of this data set also changes. In terms of this change or modification in the quality factor, it can be decreased, i.e. reduced, or increased, or improved. The invention thus makes provision for the quality factor to be improved in the best case with increasing detection of the vehicle. The more often a vehicle is detected or a data set is acquired, the higher the degree of significance of an identity comparison between two data sets that have been acquired at different times.

In addition, it is conceivable, as an alternative or in addition, that the analysis unit additionally searches the data sets for known visual and/or acoustic information already acquired at an earlier time and assigned to a vehicle and, in the absence of visual and/or acoustic information already acquired in the data set, the analysis unit determines what has been indicated by said information. If visual and/or acoustic information is acquired for the first time, the analysis unit can also determine what is identified by said information.

In the absence of such visual and/or acoustic information, the analysis unit decides whether said information can be omitted for the assignment of the data set to a particular vehicle. In addition, a check is performed to determine whether the missing information can be added to the data set by pattern recognition, preferably by artificial intelligence. In the case of newly acquired acoustic or visual information, pattern recognition, preferably artificial intelligence, determines whether said information matches the data set and, if applicable, this is added to the data set. The analysis unit takes this information as a basis for deciding whether the newly acquired information indicates an unauthorized replacement of vehicle components. The acquisition and detection of visual and acoustic information can thus be used in addition to the detection of RFID transponders to check the identity of the vehicle. In this case, too, in the absence or in the case of an addition of visual and/or acoustic information or an adaptation of a data set, the quality factor of the data set can be modified, preferably decreased or increased.

In particular, the invention may make provision for the location and/or the time of the acquisition of the data set to also be taken into account in the determination of the plausibility factor. This location and/or time stamp provides the analysis device with additional valuable data in order to determine the plausibility of whether two data sets that have been acquired at different times belong to the same vehicle.

It is preferably conceivable that, when RFID transponders of the same type are read at the same time and at the same location, it is determined whether these data sets can be assigned to different vehicles. Especially on busy roads, it cannot be ruled out that the reader is simultaneously detecting multiple RFID transponders belonging to different vehicles. However, the different transponders can be assigned to different vehicles using pattern recognition or artificial intelligence.

It is also conceivable that, when the information stored on an RFID transponder is not complete or not completely readable, it is completed by pattern recognition, preferably artificial intelligence, based on the data sets stored on the data memory.

Finally, it is also conceivable that the RFID transponders and/or the characteristics of a vehicle are detected by a plurality of RFID readers and/or other data acquisition instruments, wherein all RFID readers and/or other data acquisition instruments are electronically linked to one another. It is thus conceivable that the readers are arranged at different positions next to, above and in the road in order to preferably cover the entirety of the road. It is also conceivable that multiple readers are arranged at a certain distance from one another in order to directly verify recorded data. By linking all readers and the analysis unit(s) and central or local data storage, the recorded data can be analyzed regardless of location and at least virtually simultaneously and, if necessary, measures can be taken to counter irregularities. For example, it is conceivable that vehicles that have been detected with a low plausibility factor are compared with a database that lists suspicious vehicles. This direct comparison means that it is possible to take action against data or vehicle theft very quickly.

A system for solving the stated problem has the features of claim 20. Provision is accordingly made for a system for carrying out a method for identifying a vehicle as claimed in claim 1 to be provided. This system has at least one analysis unit, at least one RFID reading device for reading RFID transponders and/or at least one camera for acquiring visual information about the vehicle. In addition, the system may have at least one microphone, which can be used to acquire acoustic information, such as vibrations of the tires.

One preferred exemplary embodiment of the invention is explained in more detail below with reference to the drawing.

The block diagram shown in the fig illustrates the method according to the invention in a highly schematic manner. Accordingly, first, a large number of RFID transponders are read or information from a vehicle is acquired (data acquisition 12) by a reader or other sensor unit. This data acquisition 12 takes place in one location at a specific time. Both the location and the time are buffer-stored, together with the data from the RFID transponders and the vehicle, as a data set in a data memory 11. This data memory 11, which serves as record keeping system, can be positioned and managed centrally or locally.

An analysis device 10 has access to this data memory 12. This analysis device 10 can also be arranged centrally or locally. All data sets from different vehicles are first recorded and managed by means of the analysis device 10. Through the continuous further data acquisition 13 of a large number of vehicles with a large number of RFID transponders, a large database of data sets for different vehicles can be created over time.

The analysis device 10 assigns a quality factor for each data set depending on the information stored in a data set for a vehicle. This quality factor evaluates the quality of the data set or the suitability of the data set for identifying a specific vehicle. As already mentioned, each data set contains the data from a large number of RFID transponders assigned to a vehicle. However, a data set contains at least the data from an RFID transponder, on which data about the vehicle and/or the vehicle owner are stored, and/or data from an RFID transponder that identifies a component of the same vehicle and at least one further RFID transponder that is attached to the same vehicle. In addition, it is also conceivable that additional information, for example visual or acoustic information, about the vehicle is stored in the data set.

Data sets with a large number of such data and information tend to have a higher quality factor than data sets with only little data from a few RFID transponders. The quality factor also increases when a vehicle is detected more often and the data and information about that vehicle are read and validated more often. If there is also a lot of data and information available for a vehicle and this is validated regularly by re-detecting the vehicle, this data set has a high quality factor. Such a data set is particularly well suited for identifying or authenticating the vehicle or the license plate.

If the analysis device 10 identifies that an acquired data set has more or less data or information compared to an older data set for the same vehicle, the analysis device 10 can determine whether the quality factor is increased or decreased as a result. Similarly, the analysis device 10 detects whether, for example, an additional RFID transponder is a vehicle-identifying feature or an object that has been temporarily brought into the vehicle by a passenger. For example, if a shock absorber has been replaced, the analysis device 10 takes the RFID transponder of the new shock absorber as a basis for detecting that the new RFID transponder is a transponder of the new shock absorber, which is likely replacing an old shock absorber. In this case, the data in the data set is exchanged without changing the quality factor. If the RFID transponder of the shock absorber is registered for the first time, this can lead to an improvement in the quality factor. If a previously known RFID transponder of a shock absorber is no longer detected, these data can be removed from the data set, which can lead to a reduction in the quality factor. However, it cannot be ruled out that some transponders are simply not recognized or read by the readers when the RFID transponders of a vehicle are read again. In such a case, the analysis device 10 can use pattern recognition, which may be, for example, artificial intelligence, to check whether the undetected RFID transponder can be omitted for the creation of a data set. The quality factor of a data set is therefore subject to constant modification or improvement.

If the analysis device 10 determines a data set of a vehicle, this is compared with data sets already stored in the data memory 11. In the course of such a comparison, the analysis device 10 creates a plausibility factor indicating the probability with which the newly created data set or the newly detected vehicle is a vehicle that has already been detected. If this vehicle can only be associated with data sets that slightly correspond, the plausibility factor assigned by the analysis device 10 is very low. This typically results in the newly recorded data not being associated with the previous data sets. If the plausibility factor is sufficiently high, it can be assumed that the vehicle detected at a different time is an already known vehicle. This results in determined data sets possibly being combined with one another and the quality factor of the data set being adapted to a specific vehicle.

If a data set for a vehicle is now acquired and this data set corresponds to an already known data set with an increased plausibility, the analysis device 10 verifies the type of differences between the data sets. If, for example, the data from all RFID transponders and other information correspond but not the data from the RFID transponder assigned to the identifier, it can be assumed that the vehicle has a forged license plate or number plate. It is therefore possible to detect potential forgery of license plates 17. In the rest of the method, these data are compared with a list of already known and suspicious vehicles 16 stored in the analysis device 10 or the data memory 11. If this results in changes to a potential forgery or it turns out that it is not a forgery, the list of suspicious vehicles will be updated 18. However, if the analysis shows that there is a forgery, the relevant authority will be notified immediately so that appropriate measures can be taken.

### LIST OF REFERENCE SIGNS

10 Data analysis device
11 Data memory
12 Data acquisition
13 Acquisition of additional data
14 Determination of a quality factor
15 Determination of a plausibility factor
16 Exposure of forgeries
17 Comparison of suspicious vehicles
18 Updating of the list of/with suspicious vehicles

1. A method for identifying a vehicle, wherein a plurality of RFID transponders, but at least one RFID transponder, on which data about the vehicle and/or the vehicle owner are stored, and/or an RFID transponder that identifies a component of the same vehicle and at least one further RFID transponder that is attached to the same vehicle
1. are read by at least one RFID reader,
2. the set of data (data set) that has been read from all the read transponders of the same vehicle are stored, together with the location and the time at which the data were read, in a central or local data memory,
3. the data set that has been read is analyzed by an analysis device,
4. wherein the data set that has been read is evaluated with a quality factor by the analysis device,
5. a data set is also created from RFID transponders of a vehicle that are read at a later time and this data set is compared with the previously recorded data sets and their quality factors, and
6. a plausibility factor indicating the plausibility of two data sets that have been recorded at different times belonging to the same vehicle is generated by way of the analysis device matching the data sets and/or the quality factors.

2. The method for identifying a vehicle as claimed in claim 1, wherein, when the plurality of RFID transponders of a vehicle are read at a later time, the quality factor of a data set belonging to a vehicle is updated.

3. The method for identifying a vehicle as claimed in claim 1, wherein at least one camera is used to determine additional visible data of the vehicle (visual information) and these data are also stored in the data set and analyzed.

4. The method for identifying a vehicle as claimed in claim 1, wherein at least one additional sensor is used to determine the noise (acoustic information) of the tires, the shock absorbers, the exhaust and/or the drive chain or similar and these data are also stored in the data set and analyzed.

5. The method for identifying a vehicle as claimed in claim 1, wherein data sets that do not reach a value to be stipulated for a quality factor, because too few transponders have been detected or other data or information are/is missing, are not used for further identification of the vehicle.

6. The method for identifying a vehicle as claimed in claim 1, wherein the calculated plausibility factor from which two data sets that have been recorded consecutively can be assigned to the same vehicle is stipulated.

7. The method for identifying a vehicle as claimed in claim 1, wherein a signal is generated when a stipulated plausibility factor that must be reached for two data sets that have been recorded consecutively to be attributed to the same vehicle is undershot.

8. The method for identifying a vehicle as claimed in claim 7, wherein the signal is a message to an official institution.

9. The method for identifying a vehicle as claimed in claim 1, wherein the analysis unit searches the data sets for known RFID transponders already detected at an earlier time and assigned to a vehicle and,
a) in the absence of an already detected RFID transponder in the data set, the analysis unit determines what has been indicated by the RFID transponder,
b) when an RFID transponder that has not yet been stored in the data set is first detected, the analysis unit also determines what has been indicated by the RFID transponder.

10. The method for identifying a vehicle as claimed in claim 9, wherein,
a) in the absence of an RFID transponder, the analysis unit decides whether this RFID transponder can be omitted for the assignment of the data set to a particular vehicle and/or
b) the missing RFID transponder can be added to the data set by pattern recognition, and/or
c) in the case of a newly detected RFID transponder, pattern recognition determines whether the RFID transponder matches the data set and, if applicable, this is added to the data set.

11. The method for identifying a vehicle as claimed in claim 9, wherein, in the absence or in the case of an addition of an RFID transponder or an adaptation of a data set, the quality factor of the data set is modified.

12. The method for identifying a vehicle as claimed in claim 1, wherein the analysis unit additionally searches the data sets for known visual and/or acoustic information already acquired at an earlier time and assigned to a vehicle and
a) in the absence of visual and/or acoustic information already acquired in the data set, the analysis unit determines what has been indicated by the information,
b) when visual and/or acoustic information that has not yet been stored in the data set is first acquired, the analysis unit also determines what has been indicated by the information.

13. The method for identifying a vehicle as claimed in claim 12, wherein,
a) in the absence of visual and/or acoustic information, the analysis unit decides whether the information can be omitted for the assignment of the data set to a particular vehicle and/or
b) the missing information can be added to the data set by pattern recognition, and/or
c) in the case of newly acquired visual and/or acoustic information, pattern recognition determines whether the information matches the data set and, if applicable, this is added to the data set, and/or
d) the analysis unit decides whether the newly acquired information indicates an unauthorized replacement of vehicle components.

14. The method for identifying a vehicle as claimed in claim 12, wherein, in the absence or in the case of an addition of visual and/or acoustic information or an adaptation of a data set, the quality factor of the data set is modified.

15. The method for identifying a vehicle as claimed in claim 1, wherein the location and the time of acquiring the data set is also taken into account in the determination of the plausibility factor.

16. The method for identifying a vehicle as claimed in claim 1, wherein when RFID transponders of the same type are read at the same time and at the same location, it is determined whether these data sets can be assigned to different vehicles.

17. The method for identifying a vehicle as claimed in claim 1, wherein, when the information stored on an RFID transponder is not complete or not completely readable, it is completed by pattern recognition based on the data sets stored on the data memory.

18. The method for identifying a vehicle as claimed in claim 1, wherein the RFID transponders and/or the characteristics of a vehicle are detected by a plurality of RFID readers and/or other data acquisition instruments, wherein all RFID readers and/or other data acquisition instruments are electronically linked to one another.

19. The method for identifying a vehicle as claimed in claim 1, wherein data sets that are assigned to a vehicle are compared with a database in which suspicious vehicles are listed.

20. A system for carrying out a method for identifying a vehicle as claimed in claim 1 having an analysis unit and at least one RFID reading device for reading RFID transponders and/or at least one camera for acquiring visual information from the vehicle and/or at least one microphone for acquiring acoustic information from the vehicle.
